(19) United States
(12) Patent Application Publication
(10) Pub. No.: US 2023/0139855 A1
(43) Pub. Date: May 4, 2023

(54) Pool Skimmer Cleaner

(71) Applicant: Greg Priddy, Montgomery, TX (US)

(72) Inventor: Greg Priddy, Montgomery, TX (US)

(21) Appl. No.: 17/935,272

(22) Filed: Sep. 26, 2022

Related U.S. Application Data
(60) Provisional application No. 63/275,673, filed on Nov. 4, 2021.

(51) Int. Cl. C02F 1/40; B25G 1/04

(52) U.S. Cl. CPC C02F 1/40; B25G 1/04; C02F 2103/42

(57) ABSTRACT

The present invention relates generally to the field of recreational accessories for pools, spas, and hot tubs. More specifically, the present invention relates to a skimmer cleaner or accessory. The device has a hooked attachment, a netted attachment, a handle, at least one connection member, at least one button, and at least one locking mechanism. In varying embodiments, there may be differentiating attachments that may be connected to the handle such as a claw attachment. The netted attachment provides a means to retrieve debris from the pool. The hooked attachment provides a way to retrieve the skimmer basket from the pool. The claw member allows a user to be able to grab onto the skimmer basket or other objects.

### CROSS-REFERENCE TO RELATED APPLICATION

The present application claims priority to, and the benefit of, U.S. Provisional Application No. 63/275,673, which was filed on Nov. 4, 2021, and is incorporated herein by reference in its entirety.

### FIELD OF THE INVENTION

The present invention relates generally to the field of recreational accessories. More specifically, the present invention relates to a pool skimmer cleaner. The device has a hooked attachment, a netted attachment, a handle, at least one connection member, at least one button, and at least one locking mechanism. In varying embodiments, there may be differentiating attachments that may be connected to the handle such as a claw attachment. The netted attachment provides a means to retrieve debris and other clutter from the pool. The hooked attachment provides a way to retrieve lids and heavier items from the pool. The claw attachment allows a user to be able to grab onto items that will not fit into the skimmer or other objects that are out of the reach of the user. In a differing embodiment, the device may have at least one light source that provides a way to use the pool cleaning tool in low light conditions. The light source may be further powered by at least one battery and operated by at least one button. Accordingly, the present disclosure makes specific reference thereto. Nonetheless, it is to be appreciated that aspects of the present invention are also equally applicable to other like applications, devices, and methods of manufacture.

### BACKGROUND

Properly maintaining commercial and residential pools, hot tubs, and spas is a very meticulous process that involves a lot of manual labor on the part of pool owners, maintenance personnel, and technicians. There are many challenges that come with cleaning pools, hot tubs, and spas. Dealing with skimmer lids and tower chlorinator lids is very difficult. These lids get stuck to the ground when stepped on, swell and suction in the heat, and, at times, are generally very difficult to remove for cleaning and maintenance. Hitting the lids or covers with hammers or other tools to loosen the lids can easily break them, causing equipment to malfunction and resulting in replacement costs. But failure to remove the lids and clean the skimmer baskets can lead to a buildup of leaves and other line clogging debris that cost time and money to fix. Even when lids or covers come off easily, other challenges are encountered with skimmer maintenance. For example, the baskets provide a great hiding and nesting place for various insects and animals, such as poisonous snakes, making it dangerous to clean them out by hand. Aside from the struggles of manual cleaning, individuals with physical limitations, such as knee or back problems, may be unable to bend over to complete tasks such as emptying skimmer baskets. These consumers are at risk for falling into the pool and potentially drowning.

Therefore, there exists a long-felt need in the art for a pool skimmer cleaner that provides a way for a user to easily remove the skimmer lid or cover with minimal effort. Further, there exists a long-felt need in the art for a pool skimmer cleaner that eliminates the need for a user to get on their hands and knees to remove the skimmer lid or cover. There also exists a long-felt need in the art for a pool skimmer cleaner that removes the risk of breaking the plastic housing when removing the skimmer lid or cover. There also exists a long-felt need in the art for a pool skimmer cleaner that provides the user with a way of removing the skimmer basket without having to get on their hands or knees. Further, there exists a long-felt need in the art for a device that allows a user to retrieve the skimmer basket or bucket without having to place their hand into an area that may house dangerous animals, insects, or other hazards.

The present invention, in one exemplary embodiment, is a pool skimmer cleaner. In one embodiment, the device has a handle, a netted attachment, a hooked attachment, at least one connection member, at least one button, and at least one locking mechanism. In one embodiment, the device may have a plurality of additional attachments that may be removably connected to the handle such as a claw attachment. In another embodiment, the device may have a light source powered by at least one battery to help a user see in low light conditions.

In this manner, the pool skimmer cleaner of the present invention accomplishes all of the foregoing objectives and provides a novel pool cleaning device that provides users with a way to remove and clean the skimmer basket or bucket of the pool without having to get on their hands and knees.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

In one exemplary embodiment, a recreational accessory for a pool, spa, or hot tub includes a handle having a first end and a second end. A first attachment to connect to the first end and a second attachment to connect to the second end of the handle. Each of the first and second attachments are secured to the handle by a fastener. At least one of the first and second attachments is removable and interchangeable with one or more additional attachments. The handle preferably comprises one or more gipping areas to facilitate holding of the handle. The first and second attachments are different from one another.

The subject matter disclosed and claimed herein, in one embodiment thereof, comprises a pool skimmer cleaner. The device includes a body, an elongated or telescoping handle, a hooked attachment, a netted attachment, at least one connection member, and at least one fastener.

The invention has at least one netted attachment with at least one net, at least one connection member, and at least one fastener to secure the netted attachment to the elongated handle. The netted attachment is further attached to the handle via one or more connection members. The connection member may be telescoping in that the netted attachment may be extended to reach a plurality of lengths. The netted attachment is locked at the desired length via at least one button and at least locking mechanism. When the user presses the button, the locking mechanism is engaged which prevents the netted attachment from becoming lose and sliding back into the handle. Further, when the user presses the button a second time, the locking mechanism is disengaged, and the distance of the connection member may be changed.

In one embodiment, the netted attachment is fixed to the handle and is not interchangeable. In another embodiment, the netted attachment is interchangeable and is removable from the handle. In the removable embodiment, the netted attachment is attached to the handle by the connection member via a fastener. The fastener allows the user to attach and detach a plurality of attachments to accomplish a plurality of different tasks.

In the preferred embodiment, the pool accessory or cleaner includes at least one hooked attachment. The hooked attachment has at least one hook, at least one connection member, and at least one fastener. The hooked attachment is further attached to the handle via a connection member. The connection member may be telescoping in that the hooked attachment may be extended to reach a plurality of lengths. Further, the hooked attachment is locked and unlocked in the same way as the netted attachment. In one embodiment, the hooked attachment is fixed to the handle, while in another embodiment, it is removable via at least one fastener. The hook provides a user with a way to remove the lid to the skimmer, or to retrieve the skimmer to empty it. The hook further eliminates the need for the user to bend over at retrieve the skimmer.

In a different embodiment, the invention may include an additional claw attachment to grab and retrieve the skimmer basket or bucket from the pool or the skimmer housing. The claw attachment has at least one stationary member, at least one movable member, and at least one actuation lever.

The claw attachment is removably attached to the handle via a connection member. The connection member may be telescoping in that the claw attachment may be extended to reach a plurality of different lengths. The claw attachment may be locked and unlocked at the desired length the same way as the hooked attachment and netted attachment.

In one embodiment, the claw attachment is fixed to the handle and is not interchangeable. In another embodiment, the claw attachment is interchangeable and is removable from the handle. In the removable embodiment, the claw attachment is attached to the handle by the connection member via a fastener. The fastener may be any fastener known in the art but is preferably a twistable threaded fastener, snap connect, magnetic, or other suitable connection point.

The claw attachment member further includes a stationary member and a movable member. The movable member is changeable by at least one hinge. The movable member is further operated by at least one lever. When a user presses the lever in, the movable member is closed thus grabbing the skimmer basket or other items. When the user releases the lever, the movable member opens, and the skimmer basket or other item is released.

In one embodiment, the device has at least one light source and at least one battery. The light source provides a user with a way to use the invention when lighting or visibility are limited or when the user may just want some additional light. This allows a user to be able to use the device in all conditions. The light source is further powered by at least one battery.

Accordingly, the pool accessory, or pool skimmer cleaner of the present invention is particularly advantageous as it provides a novel means for cleaning or servicing a pool, specifically the skimmer basket or bucket. The invention prevents a user from having to get on their hands and knees to pull out the skimmer basket. Further, the pool accessory prevents the need to stick or place an arm or hand into the skimmer area which can house insects, animals, and other hazards. In this manner, the pool accessory or skimmer cleaner overcomes the limitations of existing problems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pool accessory or skimmer cleaner of the present invention in accordance with the disclosed architecture;

FIG. 2 illustrates a perspective view of one potential embodiment of a pool accessory or skimmer cleaner with an additional attachment feature of the present invention in accordance with the disclosed architecture;

FIG. 3 illustrates a flowchart of one potential method of using one potential embodiment of the pool accessory or skimmer cleaner of the present invention in accordance with the disclosed architecture;

FIG. 4 illustrates the contents of one potential embodiment of a kit for assembling a pool accessory or pool cleaner of the present invention in accordance with the disclosed architecture; and

FIG. 5 illustrates a perspective view of an end of one potential embodiment of a pool accessory or skimmer cleaner of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a pool accessory or skimmer cleaner that provides a way for users to easily remove the skimmer lid and skimmer basket with minimal effort. Further, there exists a long-felt need in the art for a pool accessory or skimmer cleaner that eliminates the need for a user to get on their hands and knees to remove the skimmer lid and skimmer basket. There also exists a long-felt need in the art for a pool accessory or skimmer cleaner that removes the risk of breaking the plastic housing around the skimmer area when removing the skimmer lid and skimmer basket. There also exists a long-felt need in the art for a pool accessory or skimmer cleaner that provides the user with a way of removing the skimmer lid, covers and basket without having to get on their hands or knees. Further, there exists a long-felt need in the art for a device that allows a user to retrieve the skimmer cover and basket without having to place their hand into an area that may house dangerous animals, insects, or other hazards.

The present invention, in one exemplary embodiment, is a pool accessory such as a skimmer cleaner. In one embodiment, the device has a telescoping handle having a first end and a second end, a removable or interchangeable netted attachment placed at one of the first and second ends, a removable or interchangeable hooked attachment provided at the other of the first and second end, at least one connection member, at least one button, and at least one locking mechanism. The invention includes telescoping connection members which allows a user to use the device at a plurality of different lengths. Further, the connection members are locked and unlocked via a locking mechanism which is operated by a button or switch. In one embodiment, the hooked attachment and the netted attachment are fixed to the handle. In another embodiment, they are removable or interchangeable and allow for a plurality of attachments to be fastened to the handle to accomplish a multitude of tasks. In one embodiment, the pool accessory has a claw attachment that may be removably attached to the handle. In this embodiment, the claw attachment has a movable member that is controlled via at least one lever or switch. This provides a way for a user to grab the skimmer cover and/or basket or other objects with the device. In a different embodiment, the device may have at least one light source powered by at least one battery. The light source provides a way for a user to use the device in poor visibility or poorly lit areas, or simply to provide additional light to the work area.

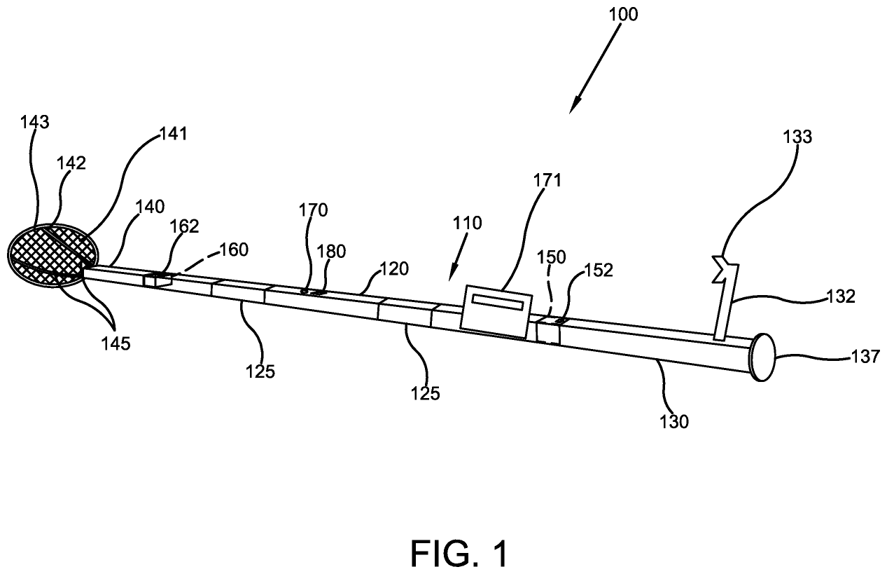

Referring initially to the drawings, FIG. 1 illustrates a perspective view of one potential embodiment of a pool accessory or skimmer cleaner 100 with a hook 132 attached to the handle of the present invention in accordance with the disclosed specification. The device 100 has a body 110, including a handle 120, at least one hooked attachment 130, at least one netted attachment 140, at least one connection member 150, 160, and at least one fastener 152, 162. The handle 120 may be provided with one or more gipping areas 125 which may be a non-slip material such as rubber, silicone, or combinations thereof. The gripping areas 125 may have a series of undulating ridges or other patterns to facilitate holding and gripping of the handle. The gripping areas have a width from about three to five inches.

The body 110 includes a telescoping handle 120. In the preferred embodiment, the handle 120 is manufactured from a metal material such as, but not limited to, brass, copper, aluminum, stainless steel, marine grade aluminum, or combinations thereof. In another embodiment, the handle 120 may be manufactured from a rigid plastic material such as, not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, recycled plastic, biodegradable plastic, or combinations thereof. In one embodiment, the handle may be non-telescopic and made from a one-piece construction.

The pool accessory 100 has at least one netted attachment 140. The netted attachment 140 includes at least one net 142, at least one connection member 160, and at least one fastener 162. The netting or mesh 141 of the netted attachment is one of an ultra-fine mesh or a fine mesh and having a mesh number that may range from approximately 20 mesh to 100 mesh with about 40 to 60 mesh size being preferred. The mesh of the netted attachment may be provided in a relatively planar arrangement with the frame 143 of the netted attachment 140. The frame 143 may have one or more supporting ribs 145 to provide support strength to the mesh 141. The ribs may have a thickness of between ⅛″ and ½″ and are generally semi-rigid to allow the mesh 141 to have some flexibility. Alternatively, the mesh 141 may form a pocket with the frame 143 to form a collection area for catching debris. The pocket area may have a depth ranging from two inches to about eight inches with about three to five inches being preferred.

The netted attachment 140 is further attached to the handle 120 via a connection member 160. The connection member 160 may be telescoping in that the netted attachment 142 may be extended to reach a plurality of differing lengths. In another embodiment, the netted attachment 140 is locked at the desired length via at least one button 170. When the user presses the button 170, a locking mechanism 180 is engaged which prevents the netted attachment 142 from becoming lose and sliding back into the handle 120. The locking mechanism 180 may be any locking mechanism known in the art such as, but not limited to: a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed core lock, or combinations thereof. Further, when the user presses the button 170 a second time, the locking mechanism 180 is disengaged and the distance of the connection member 160 may be changed.

In one embodiment, the netted attachment 140 is fixed to the handle 120 and is not interchangeable. In another embodiment, the netted attachment 140 is interchangeable and is removable from the handle 120. In the removable embodiment, the netted attachment 140 is attached to the handle 120 by the connection member 160 via a fastener 162. The fastener 162 allows the user to attach and detach a plurality of attachments to accomplish a multitude of different tasks. The fastener 162 may be any fastener known in the art but is preferably a twistable threaded fastener. The net 142 may be any net known in the art that allows users to retrieve leaves, bugs, grass, and other debris from the pool, spa, or hot tub. Further, the net 142 may be made from a plurality of materials such as, but not limited to: tulle, bobbinet, fishnet, French net, Russian netting, nylon, polyester, English net, industrial net, fence net, and combinations thereof.

In the preferred embodiment, the device 100 is includes at least one hooked attachment 130 that can be used for (but not limited to) removing pool cleaner hoses from a pool. The hooked attachment 130 has at least one hook 132, at least one connection member 150, and at least one fastener 152. The hooked attachment 130 is further attached to the handle 120 via a connection member 150. The connection member 150 may be telescoping in that the hooked attachment 130 may be extended to reach a plurality of lengths. The hook 132 may include an additional catch or grapple 133 to help hold the skimmer basket handle when being removed from the skimmer enclosure. The catch or grapple 133 may be manufactured from a hard rubber or other semi-rigid material so as not to puncture the interior of the skim enclosure. A magnet 137 may be applied to the end of the handle 120 for use in picking up nails, staples, pins, or other metal objects that may have fallen into the pool and which have slipped through the skimmer basket. The magnet 137 may be manufactured from one of neodymium iron boron (NdFeB), samarium cobalt (SmCo), alnico, and ceramic or ferrite material. The handle 120 may also have a water sample collector 171 which can be used to collect a water sample from a pool, spa, or hot tub without the user having to bend over to collect the sample. The sample collector 171 may hold between three and six ounces with about three to five ounces being preferred. The sample collector 171 may also be divided into multiple compartments, such as three compartments to test different attributes of the water such as pH, chlorine levels and bromine levels.

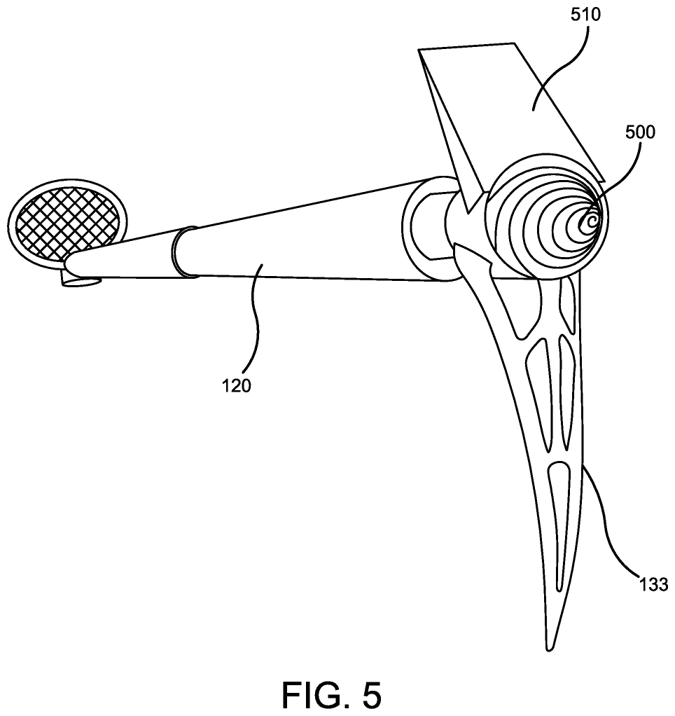

As seen in FIG. 5, in one embodiment the end of the handle 120 may be comprised of at least one spike 500 and at least one jet removal tool 510. The spike 500 is preferably comprised of a pointed spike 500 that allows for pivotal movements of the device 100 during use. The jet removal tool 510 is preferably comprised of a generally triangular tool. The shape of the tool 510 is preferably an acute triangle. The shape of the tool 510 is optimized to aid a user in removing the eyeball assembly (jet) from a pool wall, wherein the tool 510 preferably engages slots found on the pool jet to release the jet from the pool wall.

In a differing embodiment, the hooked attachment 130 is locked at the desired length via at least one button 170. When the user presses the button 170, a locking mechanism 180 is engaged which prevents the hooked attachment 130 from becoming lose and sliding back into the handle 120. The locking mechanism 180 may be any locking mechanism known in the art such as, but not limited to: a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed core lock, and combinations thereof. Further, when the user presses the button 170 a second time, the locking mechanism 180 is disengaged and the distance of the connection member 150 may be changed.

In one embodiment, the hooked attachment 130 is fixed to the handle 120 and is not interchangeable. In another embodiment, the hooked attachment 130 is interchangeable and is removable from the handle 120. In the removable embodiment, the hooked attachment 130 is attached to the handle 120 by the connection member 150 via a fastener 152. The fastener 152 allows the user to attach and detach a plurality of attachments to accomplish a multitude of different tasks. The fastener 152 may be any fastener known in the art but is preferably one of a twistable threaded fastener, snap connection, or magnetic connection.

The hook 132 provides a user with a way to remove the lid or cover to the skimmer housing, or to retrieve the skimmer basket in order to empty basket and clean out the skimmer housing. The hook 132 further eliminates the need for the user to bend over at retrieve the skimmer basket or to have to reach into the skimmer housing. The hook 132 may be any hook known in the art that provides a means for removing skimmer lids or covers and retrieving the skimmer basket from the pool. In the preferred embodiment, the hook 132 is made from a metal material such as, but not limited to: brass, copper, aluminum, stainless steel, or combinations thereof. In another embodiment, the hook 132 may be manufactured from a rigid plastic material such as, not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, recycled plastic, biodegradable plastic, or combinations thereof. The hook 132 may be any shape that allows for the removal of the skimmer lid, and the retrieval of the skimmer and the end of the hook may include an additional catch or grapple 133 to assist in the removal of the skimmer basket.

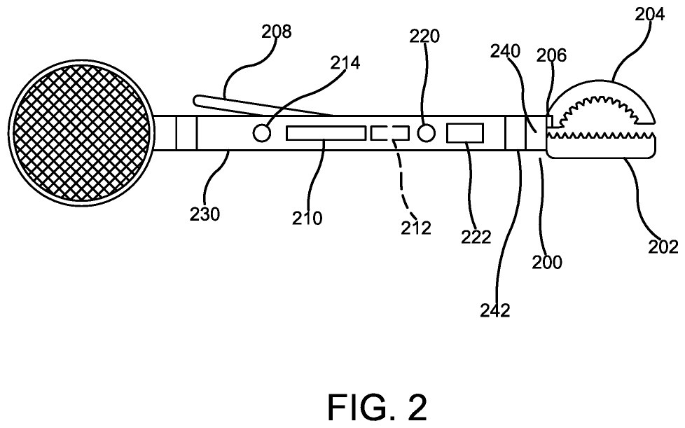

FIG. 2 illustrates a perspective view of one potential embodiment of a pool accessory or skimmer cleaner or removal device 100 with a claw attachment 200 of the present invention in accordance with the disclosed specification. In one embodiment, the device 100 may have a claw attachment 200 to grab and retrieve the skimmer basket from the pool or skimmer housing. The claw attachment 200 has at least one stationary member 202, at least one movable member 204, and at least one lever 208. The claw attachment 200 may be used to pick up other items from the pool which may be too large for the netted attachment such as a hose, sticks, toys and the like.

The claw attachment 200 is further attached to the handle 230 via a connection member 240. The connection member 240 may be telescoping in that the claw attachment 200 may be extended to reach a plurality of differing lengths.

In a further embodiment, the claw attachment 200 is locked at the desired length via at least one button 220. When the user presses the button 220, a locking mechanism 222 is engaged which prevents the claw attachment 200 from becoming lose and sliding back into the handle 230. The locking mechanism 222 may be any locking mechanism known in the art such as, but not limited to: a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed core lock, or combinations thereof. Further, when the user presses the button 220 a second time, the locking mechanism 222 is disengaged and the distance of the connection member 240 may be changed.

In one embodiment, the claw attachment 200 is fixed to the handle 230 and is not interchangeable. In another embodiment, the claw attachment 200 is interchangeable and is removable from the handle 230. In the removable embodiment, the claw attachment 200 is attached to the handle 230 by the connection member 240 via a fastener 242. The fastener 242 may be any fastener known in the art but is preferably a twistable threaded fastener, snap connection, or magnetic connection.

The claw attachment member 200 further has a stationary member 202 and a movable member 204. The movable member 204 and stationary member 202 may be manufactured from any suitable material known in the art such as metal, plastic or combinations thereof. The movable member 204 is further moved along at least one hinge 206. There are a plurality of hinges 206 that may be used such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, and combinations thereof. The edges of the movable member 204 and the stationary member 202 may be provided with a gripping surface 203, such as rubber or silicone, to help in holding things between the moveable member and stationary member or jaws of the claw attachment.

The movable member 204 is further operated by at least one lever 208. When a user presses the lever 208 in, the movable member 204 is closed thus grabbing the skimmer basket or other item the user is attempting to pick up. When the user releases the lever 208, the movable member 204 opens and the skimmer is released. The lever 208 may be any lever known in the art.

In one embodiment, the device 100 has at least one light source 210 and at least one battery 212. The light source 210 provides a user with a means to use the device 100 when lighting or visibility are limited. This allows a user to be able to use the device 100 in all conditions. The light source 210 further may be any light source such as, but not limited to: LED light, LCD light, fluorescent light, white light, spotlight, area light, fiber optic illuminator, incandescent, halogen, or combinations thereof. The light source 210 is further powered by at least one battery 212. The battery 212 may be a disposable battery 212 or a rechargeable battery 212 in the form of an alkaline, nickel-cadmium, nickel-metal hydride battery 212, etc., such as any 3V-12 volts DC battery 212 or other conventional battery 212 such as A, AA, AAA, etc., that supplies power to the light source 210. Throughout this specification the terms “battery” and “batteries” may be used interchangeably to refer to one or more wet or dry cells or batteries 212 of cells in which chemical energy is converted into electricity and used as a source of DC power. References to recharging or replacing batteries 212 may refer to recharging or replacing individual cells, individual batteries 212 of cells, or a package of multiple battery cells as is appropriate for any given battery 212 technology that may be used. The light source 210 may be operated via at least one button 214. In one embodiment, the button 214 may be pressed to turn the light source 210 off and on. In another embodiment, the button 214 may have a plurality of functions such as changing the brightness of the light source 210 or changing the color of the light source 210.

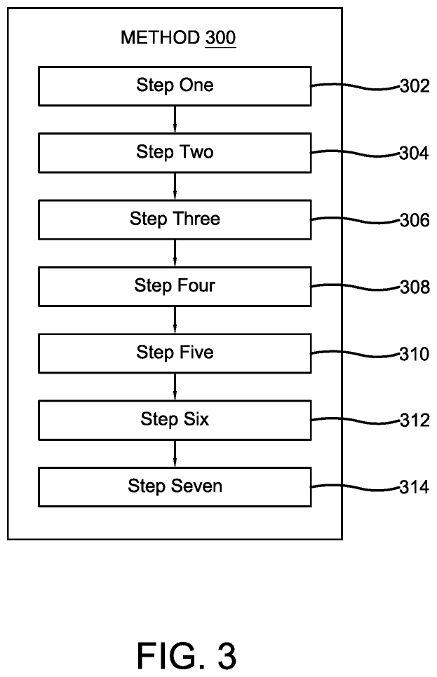

FIG. 3 illustrates a flowchart of one potential method 300 of using one potential hooked embodiment of the pool skimmer cleaner device 100 of the present invention in accordance with the disclosed specification. First, the user pulls the hooked attachment 130 out to the desired length using the telescoping connection member 150 [Step 302]. Then, the user presses the button 170 to engage the locking mechanism 180 to keep the hooked attachment 130 at the desired length [Step 304]. Next, the user uses the hook 132 to open the lid to the skimmer [Step 306]. Then, the user places the hooked attachment 130 end of the device 100 into the skimmer hole or housing to retrieve the skimmer basket [Step 308]. The user then places the hook 132 around the bar or handle on the skimmer and lifts upwards to retrieve the skimmer basket [Step 310]. The user then empties the skimmer basket and returns it to its place in the pool [Step 312]. Finally, the user presses the button 170 to release the locking mechanism 180 thus returning the hooked attachment 132 back to its original position [Step 314].

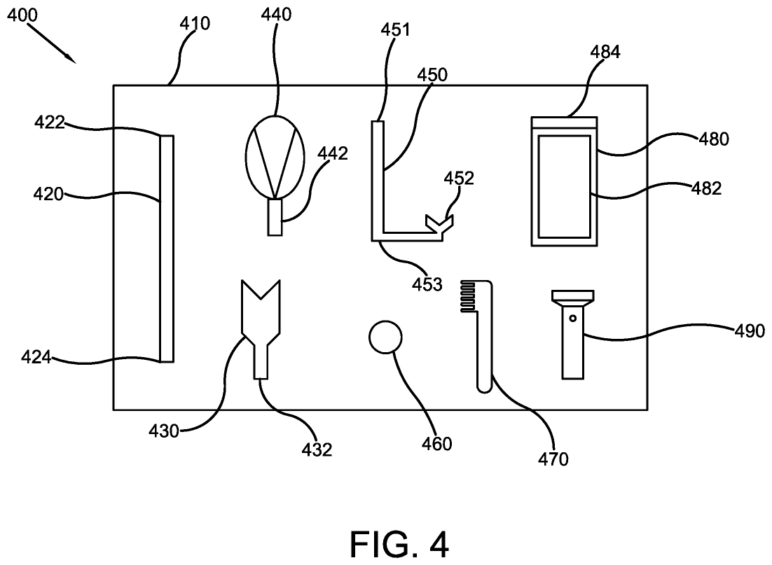

FIG. 4 shows a kit 400 which may be provided as part of a retail or online sales package to enable an individual to have the pool accessory and modify the accessory as needed for the particular purposes of the individual. The kit 400 is provided in a box, carton, or package 410 and includes a number of attachments to configure the pool accessory. A telescoping handle 420 having a first end 422 and a second end 424, a gripper attachment 430 having a connection handle 432 and a netted attachment 440 with a connection part 442. The kit 400 further includes a hook 450 which has a first portion 451 to connect to the handle 420 and a second portion 453 extending perpendicularly to the first portion 451. The second portion 453 has a grapple or catch 452 attached to the second portion 453. The kit 400 also includes a magnet 460 for attaching to the handle 420 to allow the user to pick up metal items that may not have been caught by the skimmer basket, and a brush 470 that an individual can use to brush the side walls of the pool, spa, or hot tub. The kit 400 may also include a water sampler 480 that can be attached to the handle 420 such as by a magnet or slipped over the handle using a clip or other fastener type known in the art. The sampler 480 has a window 482 to allow an individual to test the water for various chemicals and see the reagent work with the water. The sampler 480 has a lid 484 to allow water to enter the sampler and to be drained out of the sampler. A light 490 may also be included in the kit and attached to the handle. Any portion of the kit 400 may be adapted for use in removing chlorinator lids. In addition, any portion of the device 100, including a portion of the handle 120 that is flat and/or recessed, may be adapted for the same purpose.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pool skimmer cleaner device” and “device” are interchangeable and refer to the pool skimmer cleaner device 100 of the present invention.

Notwithstanding the foregoing, the pool skimmer cleaner device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pool skimmer cleaner device 100 as shown in the FIGS. are for illustrative purposes only, and that many other sizes and shapes of the pool skimmer cleaner device 100 are well within the scope of the present disclosure. Although the dimensions of the pool skimmer cleaner device 100 are important design parameters for user convenience, the pool skimmer cleaner device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A recreational accessory for a pool, spa or hot tub, the recreational accessory comprising:
a handle comprised of a first end, a second end and at least one gripping area;
a first attachment connected to the first end of the handle;
a second attachment connected to the second end of the handle, wherein the first attachment differs from the second attachment; and
a pair of fasteners for attaching the first and second attachments to the handle, wherein at least one of the first and second attachments is removable and interchangeable with a third attachment.

2. The recreation assembly as recited in claim 1, wherein the first attachment is a netted attachment comprised of a mesh.

3. The recreation assembly as recited in claim 2, wherein the mesh has a mesh size ranging between 20 and 100.

4. The recreation assembly as recited in claim 2, wherein the netted attachment comprises at least one supporting rib.

5. The recreation assembly as recited in claim 1, wherein the second attachment is a hook comprised of a first portion that connects to the handle and a second portion that extends perpendicularly to the first portion.

6. The recreation assembly as recited in claim 5, wherein the second portion comprises a catch or a grapple.

7. The recreation assembly as recited in claim 1, wherein each of the pair of fasteners is a twistable threaded fastener, a snap connect, or a magnetic fastener.

8. The recreation assembly as recited in claim 1, wherein the handle is telescoping and comprises a locking mechanism.

9. The recreation assembly as recited in claim 1, wherein the handle comprises a lighting feature, a magnet and a water sampler.

10. The recreation assembly as recited in claim 1, wherein the at least one gripping area on the handle has a width of between 3 and 5 inches.

11. The recreation assembly as recited in claim 9, wherein the lighting feature is powered by a battery.

12. A pool skimmer cleaner comprising:
a telescoping handle comprised of a first end and a second end;
a first attachment positioned on the first end; and
a second attachment positioned on the second end, wherein each of the first and second attachment are interchangeable and removable through the use of a fastener, and further wherein the first attachment is a netted attachment comprised of a mesh and a plurality of supporting ribs and the second attachment is comprised of a hook.

13. The pool skimmer cleaner as recited in claim 12, wherein the mesh has a mesh size ranging from between 20 and 100, and the plurality of supporting ribs have a width ranging from ⅛″ to ½″.

14. The pool skimmer cleaner as recited in claim 12 further comprising a claw attachment comprised of one repositionable member and one stationary member.

15. The pool skimmer cleaner as recited in claim 14, wherein each of the moveable member and the stationary member comprise a gripping surface.

16. The pool skimmer cleaner as recited in claim 12 further comprising a magnet, a water sampler and a light feature.

17. The pool skimmer cleaner as recited in claim 12, wherein the fastener is one of a twistable threaded fastener, a snap connect, or a magnet.

18. The pool skimmer cleaner as recited in claim 12, wherein the handle comprises at least one gripping area.

19. A kit for creating a recreational accessory, the kit comprising:
a package;
a telescoping handle comprised of a first end and a second end;
a netted attachment comprised of a mesh and a connection portion;
a hook attachment comprised of a first portion and a second portion, wherein the first portion connects to the handle and the second portion extends perpendicularly to the first portion and comprises a catch or a grapple; and
a claw attachment comprised of a connection portion.

20. The kit for creating a recreational accessory as recited in claim 19 further comprising a magnet, a light, a water sampler and a brush.
